(19) United States
(12) Patent Application Publication
(10) Pub. No.: US 2016/0147573 A1
(43) Pub. Date: May 26, 2016

(54) COMPUTING SYSTEM WITH HETEROGENEOUS STORAGE AND PROCESS MECHANISM AND METHOD OF OPERATION THEREOF

(71) Applicant: Samsung Electronics Co., Ltd., Suwon-si (KR)

(72) Inventors: Anahita Shayesteh, Los Altos, CA (US); Zvi Guz, Palo Alto, CA (US); Jaehwan Lee, Fremont, CA (US)

(21) Appl. No.: 14/695,747

(22) Filed: Apr. 24, 2015

Related U.S. Application Data
(60) Provisional application No. 62/083,815, filed on Nov. 24, 2014.

(51) Int. Cl. G06F 9/50

(52) U.S. Cl. CPC G06F 9/5027; G06F 9/5033; G06F 9/5038; G06F 9/5044

(57) ABSTRACT

A computing system includes: a monitor block configured to calculate a total access time based on a device access time, a traffic latency, a traffic information, or a combination thereof; a name node block, coupled to the monitor block, configured to determine a data location of a data content; and a scheduler block, coupled to the name node block, configured to distribute a task assignment based on the total access time, the data location, device performance criteria, or a combination thereof for accessing the data content from a target device.

### CROSS-REFERENCE TO RELATED APPLICATION(S)

This application claims the benefit of U.S. Provisional Patent Application Ser. No. 62/083,815 filed Nov. 24, 2014, and the subject matter thereof is incorporated herein by reference thereto.

### TECHNICAL FIELD

An embodiment of the present invention relates generally to a computing system, and more particularly to a system with heterogeneous storage and process mechanism.

### BACKGROUND

Modern consumer and industrial electronics, such as computing systems, servers, appliances, televisions, cellular phones, automobiles, satellites, and combination devices, are providing increasing levels of functionality to support modern life. While the performance requirements can differ between consumer products and enterprise or commercial products, there is a common need for efficiently storing data.

Research and development in the existing technologies can take a myriad of different directions. Some access data from disk-based storage. Others operate on cloud to access data.

Thus, a need still remains for a computing system with heterogeneous storage and process mechanism for efficiently accessing data heterogeneously. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested more efficient solutions and, thus, solutions to these problems have long eluded those skilled in the art.

### SUMMARY

An embodiment of the present invention provides a computing system, including: a monitor block configured to calculate a total access time based on a device access time, a traffic latency, a traffic information, or a combination thereof; a name node block, coupled to the monitor block, configured to determine a data location of a data content; and a scheduler block, coupled to the name node block, configured to distribute a task assignment based on the total access time, the data location, device performance criteria, or a combination thereof for accessing the data content from a target device.

An embodiment of the present invention provides a method of operation of a computing system, including: calculating a total access time based on a device access time, a traffic latency, a traffic information, or a combination thereof; determining a data location of a data content with a name node block; and distributing a task assignment based on the total access time, the data location, device performance criteria, or a combination thereof for accessing the data content from a target device.

An embodiment of the present invention provides a non-transitory computer readable medium including instructions for execution by a control unit including: calculating a total access time based on a device access time, a traffic latency, a traffic information, or a combination thereof; determining a data location of a data content; and distributing a task assignment based on the total access time, the data location, device performance criteria, or a combination thereof for accessing the data content from a target device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1A is a computing system with a heterogeneous storage and process mechanism in an embodiment of the present invention.

FIG. 1B is a computing system with the heterogeneous storage and process mechanism in a further embodiment of the present invention.

FIG. 2 is a control flow the computing system.

FIG. 3 is application examples of the computing system as with an embodiment of the present invention.

FIG. 4 is a flow chart of a method of operation of a computing system in an embodiment of the present invention.

### DETAILED DESCRIPTION

Various example embodiments include a computing system distributing a task assignment based on a device performance criteria, a storage type, network latency, worker node work load, information location, etc. or a combination thereof which improves the efficiency of the computer system. By factoring the device performance criteria, the storage type, or a combination thereof, the computing system can select the target device that can provide a data content with the quickest turnaround. As a result, the computing system can reallocate resource to operate the computing system more efficiently.

Various example embodiments include a computing system distributing the task assignment based on a total access time improves the efficiency of accessing the target device. By factoring the total access time, the computing system can select the target device that can provide the data content with the quickest turnaround. As a result, the computing system can reallocate resource to operate the computing system more efficiently.

The following embodiments are described in sufficient detail to enable those skilled in the art to make and use the invention. It is to be understood that other embodiments would be evident based on the present disclosure, and that system, process, architectural, or mechanical changes can be made without departing from the scope of an embodiment of the present invention.

In the following description, numerous specific details are given to provide a thorough understanding of the various embodiments of the invention. However, it will be apparent that various embodiments may be practiced without these specific details. In order to avoid obscuring various embodiments, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, an embodiment can be operated in any orientation.

The term “module” referred to herein can include software, hardware, or a combination thereof in an embodiment of the present invention in accordance with the context in which the term is used. For example, a software module can be machine code, firmware, embedded code, and/or application software. Also for example, a hardware module can be circuitry, processor(s), computer(s), integrated circuit(s), integrated circuit cores, pressure sensor(s), inertial sensor(s), microelectromechanical system(s) (MEMS), passive devices, or a combination thereof. Further, if a module is written in the apparatus claims section, the modules are deemed to include hardware circuitry for the purposes and the scope of apparatus claims.

The modules in the following description of the embodiments can be coupled to one other as described or as shown. The coupling can be direct or indirect without or with, respectively, intervening items between coupled items. The coupling can be physical contact or by communication between items.

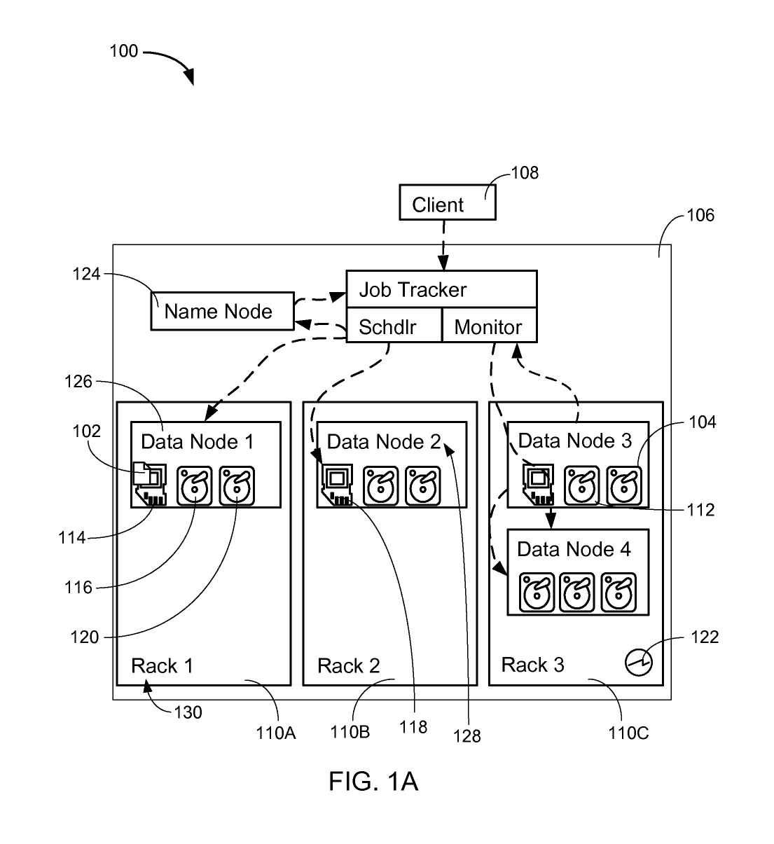

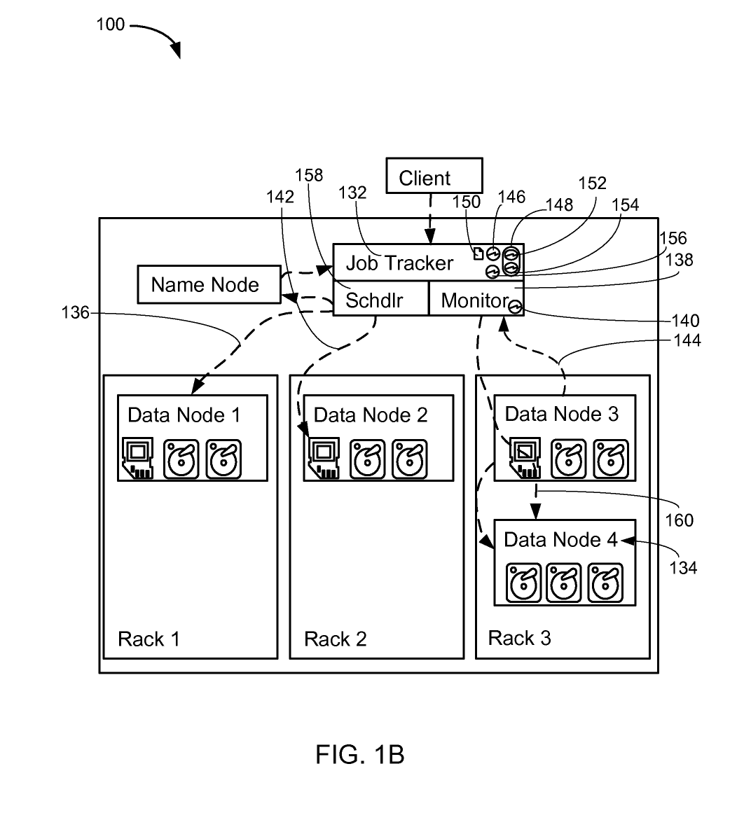

Referring now to FIG. 1A, therein is shown a computing system 100 with a heterogeneous storage and process mechanism in an embodiment of the present invention. FIG. 1 depicts one embodiment of the computing system 100 where heterogeneous storage media is used. The term heterogeneous storage can represent writing a data content 102 to a plurality of a storage type 104. Details will be discussed below.

The computing system 100 can include a computing block 106. The computing block 106 can represent a hardware device to host a heterogeneous storage architecture, a homogeneous storage architecture, or a combination thereof. Details will be discussed below.

The computing system 100 can include a client block 108. The client block 108 interacts with a data node 110. For example, the client block 108 can issue a command to write, read, or a combination thereof the data content 102 to or from a plurality of the data node 110. For a further example, the plurality of the data node 110 can represent the data node 110a, 110b, and 110c. The client block 108 can be implemented with software, hardware, such as logic gates or circuitry (analog or digital), or a combination thereof. Also for example, the client block 108 can be implemented with a hardware finite state machine, combinatorial logic, or a combination thereof. The client block 108 can be remote from the data node 110. More specifically as an example, the data node 100 can physically exist outside of the computing block 108.

The computing block 106 can include the data node 110. The data node 110 can include at least one instance of a storage unit 112 for storing the data content 102. The storage unit 112 stores the data content 102. The storage unit 112 can be a volatile memory, a nonvolatile memory, an internal memory, an external memory, or a combination thereof. The data node 110 can represent an interface to receive a command, the data content 102, or a combination thereof from the client block 108, other block within the computing block 106, or a combination thereof. The data node 110 can include a plurality of the storage unit 112 of a storage type 104.

The storage type 104 is a category of the storage unit 112. The storage type 104 can be categorized based on recording media, recording technology, or a combination thereof used to store data. The storage type 104 can be differentiated by other factors, such as write speed, read speed, latency to storage commands, throughput, or a combination thereof. For example, the storage type 104 can classify the storage unit 112 as a high performance device 114 or a low performance device 116.

The term “high” or “low” can depend on caching, firmware, network speed, throughput level, storage capacity, or a combination thereof. The high performance device 114 can represent the storage unit 112 with performance metrics exceeding those of a low performance device 116.

As an example, the high performance device 114 can be implemented with non-volatile integrated circuit memory to store the data content 102. Also for example, the low performance device 116 can represent the storage unit 112 that uses rotating or linearly moving media to store the data content 102.

For further example, the high performance device 114 and the low performance device 116 can be implemented with the same or similar technologies, such as non-volatile memory devices or rotating media, but other factors can differentiate the performance. As an example, more volatile memory as a cache can differentiate the performance of a storage unit 112 to be considered the high performance device 114 or the low performance device 116.

For example, the high performance device 114 can include a faster caching capability than the low performance device 116. For another example, the high performance device 114 can include a firmware that performs better than the low performance device 116. For a different example, the high performance device 114 can be connected to a network that provides faster communication than the low performance device 116. For another example, the high performance device 114 can have a higher throughput level by processing the data faster than the low performance device 116. For a different example, the high performance device 114 can have a greater storage capacity than the low performance device 116.

For example, the storage type 104 can classify the storage unit 112 as a solid state drive (SSD) 118, a hard disk drive (HDD) 120, or a combination thereof. More specifically as an example, the high performance device 114 can represent an SSD 118. The low performance device 116 can represent an HDD 120. The computing system 100 can provide a heterogeneous distributed file system including one or more instances of the data node 110 including one or more instances of the storage unit 112 with one or more types of the storage type 104.

For another example, the storage type 104 can allow the computing system 100 to classify the storage unit 112 according to device performance criteria 122. The device performance criteria 122 can include throughput level, storage capacity, latency, processing capability, current-use metrics, physical location identifiers, proximity-to-processing metrics, or a combination thereof. More specifically as an example, one instance of the storage unit 112 can have the device performance criteria 122 with a greater throughput than another instance of the storage unit 112. As a result, that one instance of the storage unit 112 can be faster than another instance of the storage unit 112, as indicated by the device performance criteria 122.

The computing block 106 can include a name node block 124 for receiving a request for a list of a plurality of a target device 126 for locating the data content 102. The target device 126 stores the data content 102. The computing block 106 can include the target device 126. The target device 126 can represent the data node 110, the storage unit 112, or a combination thereof. The target device 126 can represent one or more instances of the data node 110 available for reading/writing the data content 102. The target device 126 can represent one or more instances of the storage unit 112 within the data node 110 for reading/writing the data content 102.

For another example, the one instance of the target device 126 can replicate the data content 102 from another instance of the target device 126. More specifically as an example, the data node 110 including the low performance device 116 can receive the data content 102 from the data node 110 including the high performance device 114.

A target count 128 refers to the number of the target device 126 available. The target count can indicate a number of target devices 126 on which to replicate data content 102, read data content 102, or a combination thereof from. For example, the target count 128 can represent a number of instances of the data node 110 desired for reading/writing the data content 102. For a different example, the target count 128 can represent a number of the storage unit 112 available for reading/writing the data content 102.

In a heterogeneous distributed file system, the target count 128, for example, can represent four instances of the data node 110. However, the target count 128 can range from a number greater than zero to n instances of the target device 126. The name node block 124 can be implemented with software, hardware, such as circuitry or logic gates (analog or digital), or a combination thereof. Also for example, the name node block 124 can be implemented with a hardware finite state machine, combinatorial logic, or a combination thereof. More specifically as an example, the name node block 124 can provide a list of instances of the data node 110 with a variety of the storage type 104 including the high performance device 114, the low performance device 116, or a combination thereof for reading the data content 102.

The name node block 124 can select additional instances of the data node 110 based on a target location 130. The target location 130 is determined by information regarding where the target device 126 exists. The target location 130 can be expressed in a number of ways. For example, the target location 130 can be represented as a physical location, a network address, rack information, or a combination thereof.

For a specific example, the target location 130 can represent the rack information where the target device 126 is set up. For a specific example, the target location 130 where a first instance of the target device 126 can be setup is at rack 1. Continuing with the example, the target location 130 for a second instance of the target device 126 can be set up at rack 2. The target location 130 for a third instance and fourth instance of the target device 126 can be setup at rack 3.

For further example, the target location 130 can indicate that the target device 126 is located remotely outside of the computing block 106. For another example, the target location 130 can indicate that the target device 126 is located locally, thus, within the computing block 106.

Referring now to FIG. 1B, therein is shown a computing system 100 with a heterogeneous storage and process mechanism in a further embodiment of the present invention. The computing block 106 of FIG. 1A can include a job tracker block 132. The job tracker block 132 monitors the target device 126 of FIG. 1A. The job tracker block 132 also schedules a task. The job tracker block 132 can be implemented with software, hardware, such as logic gates or circuitry (analog or digital), or a combination thereof. Also for example, the job tracker block 132 can be implemented with a hardware finite state machine, combinatorial logic, or a combination thereof.

For further example, the job tracker block 132 can determine a data location 134 of the data content 102 of FIG. 1A. The data location 134 is location where the data content 102 is stored. For example, the data location 134 can represent the target device 126 representing the high performance device 114 of FIG. 1A.

For another example, the job tracker block 132 can issue a command, such as a read command 136. The read command 136 allows the computing system 100 to obtain or read the data content 102 from one or more instances of the target device 126.

The job tracker block 132 can include a monitor block 138. The monitor block 138 monitors the target device 126. The monitor block 138 can be implemented with software, hardware, such as logic gates or circuitry (analog or digital), or a combination thereof. Also for example, the job tracker block 132 can be implemented with a hardware finite state machine, combinatorial logic, or a combination thereof.

For further example, the monitor block 138 can determine a traffic information 140. The traffic information 140 is information on network traffic condition. For example, if there is a large volume of the data content 202 transferred between the client block 108 of FIG. 1A and the target device 126, the traffic information 140 for the network can indicate heavy use. For another example, the traffic information 140 can include a number of a target access 142 to the target device 126. The target access 142 is an execution to access the target device 126. For example, the traffic information 140 can include the number of the target access 142 representing the execution of the read command 136 to access a particular instance of the target device 126.

For a different example, the monitor block 138 can receive a heartbeat 144 from the target device 126. The heartbeat 144 is a notification to notify the status of the target device 126. For example, the monitor block 138 can determine the traffic information 140 based on an interval of receiving one or more instances of the heartbeat 144 from the target device 126.

A device access time 146 is a time required to receive an output from the target device 126. For example, the device access time 146 to receive an outcome from the low performance device 116 of FIG. 1A can be longer than the device access time 146 to receive an outcome from the high performance device 114. For a specific example, the device access time 146 can represent the speed to read the data content 102 from the target device 126.

The monitor block 138 can determine a traffic latency 148. The traffic latency 148 is a delay in networking. For example, the traffic latency 148 can include an inherent traffic latency 152, a current traffic latency 154, or a combination thereof. The inherent traffic latency 152 is a delay existing in the network due to a network specification 150. The network specification 150 can represent a technical limit of the network and gross physical parameter of the network (such as connection distance). For example, the network specification 150 can indicate the network speed for transferring the data content 102.

The current traffic latency 154 is a delay existing in the network due to the current volume of traffic in the network. A total access time 156 is an aggregation conditions including (but not limited to) the device access time 146, the traffic latency 148, the traffic information 140, or a combination thereof. The monitor block 138 can determine the current traffic latency 154, the total access time 156, or a combination thereof.

The job tracker block 132 can include a scheduler block 158. The scheduler block 158 schedules the task. The scheduler block 158 can be implemented with software, hardware, such as logic gates or circuitry (analog or digital), or a combination thereof. Also for example, the job tracker block 132 can be implemented with a hardware finite state machine, combinatorial logic, or a combination thereof.

For further example, the traffic information 140 can represent the network traffic condition based on a task assignment 160. The task assignment 160 is an issuance of task or command. For example, the scheduler block 158 can issue the task assignment 160 to read the data content 102 from the high performance device 114. For another example, the scheduler block 158 can issue the task assignment 160 to process a task to the high performance device 114 over the low performance device 116.

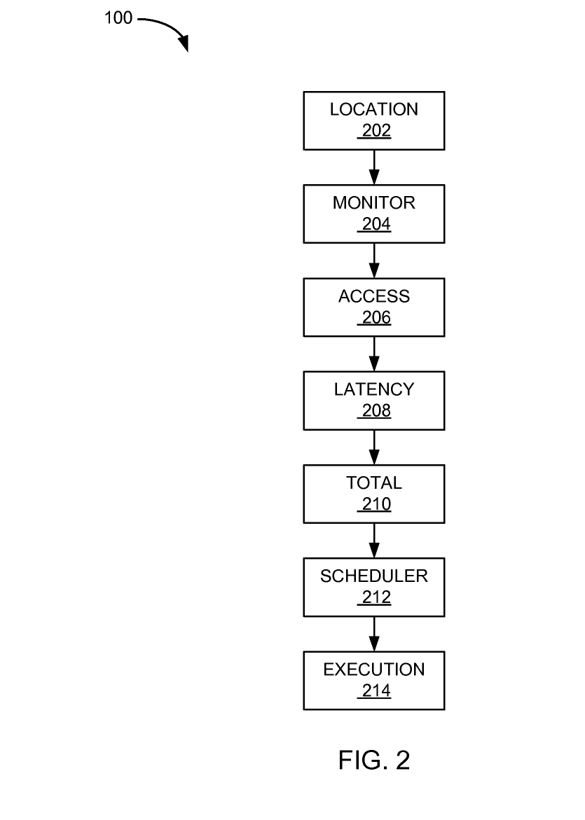

Referring now to FIG. 2, therein is shown a control flow of the computing system 100. The computing system 100 can include a location module 202. The location module 202 determines the data location 134 of FIG. 1B. For example, the location module 202 can determine the data location 134 based on the read command 136 of FIG. 1B, the target location 130 of FIG. 1A, the data content 102 of FIG. 1A, or a combination thereof.

More specifically as an example, the location module 202 can determine the data location 134 based identifying the target location 130 including the data node 110 of FIG. 1A, the storage unit 112 of FIG. 1A, or a combination thereof of where the data content 102 requested according to the read command 136 is located. The name node block 124 of FIG. 1A can execute the location module 202. The location module 202 can communicate the data location 134 to a monitor module 204.

The computing system 100 can include the monitor module 204, which can couple to the location module 202. The monitor module 204 determines the traffic information 140 of FIG. 1B. For example, the monitor module 204 can determine the traffic information 140 based on the task assignment 160 of FIG. 1B, the target device 126, the data content 102, or a combination thereof. The monitor block 138 can execute the monitor module 204.

The monitor module 204 can determine the traffic information 140 in a number of ways. For example, the monitor module 204 can determine the traffic information 140 based on the amount of the task assignment 160 assigned to access the data content 102 from the target device 126. The job tracker block 132 can provide the information regarding the network traffic of the data movement created from the task assignment 160 from one instance of the target device 126 to another instance of the target device 126.

For a different example, the monitor module 204 can determine the traffic information 140 based on the target access 142 of FIG. 1B. More specifically as an example, the monitor module 204 can determine the traffic information 140 based on a number of the target access 142 to each instances of the target device 126.

For a different example, the monitor module 204 can determine the traffic information 140 based on receiving one or more instances of the heartbeat 144 of FIG. 1B. More specifically as an example, the target device 126 can send one or more instances of the heartbeat 144 to the job tracker block 132 to be identified. Based on the heartbeat(s) 144, the monitor module 204 can determine the traffic information 140 for how fast or slow the network traffic is. The monitor module 204 can communicate the traffic information 140 to an access module 206.

The computing system 100 can include the access module 206, which can be coupled to the monitor module 204. The access module 206 determines the device access time 146 of FIG. 1B. For example, the access module 206 can determine the device access time 146 based on the storage type 104 of FIG. 1A of the target device 126. The monitor block 138 can execute the access module 206.

More specifically as an example, the access module 206 can determine the device access time 146 based on the technical specification provided for the storage type 104. For a specific example, the access module 206 can determine the device access time 146 for the target device 126 including the high performance device 114 of FIG. 1A can be faster than the device access time 146 for the target device 126 including the low performance device 116 of FIG. 1A. The access module 206 can communicate the device access time 146 to a latency module 208.

The computing system 100 can include the latency module 208, which can be coupled to the access module 206. The latency module 208 determines the traffic latency 148 of FIG. 1B. For example, the latency module 208 can determine the traffic latency 148 based on the network specification 150 of FIG. 1B, the traffic information 140, or a combination thereof. The monitor block 138 can execute the latency module 208.

The latency module 208 can determine the traffic latency 148 in a number of ways. For example, the latency module 208 can determine the inherent traffic latency 152 of FIG. 1B based on the network specification 150. More specifically as an example, the network specification 150 can provide the information regarding the maximum and minimum network speed. Based on the network specification 150, the latency module 208 can determine the inherent traffic latency 152 that the computing system 100 should expect for assigning the task assignment 160.

For a different example, the latency module 208 can determine the current traffic latency 154 of FIG. 1B based on the traffic information 140. As discussed above, the traffic information 140 can provide information related to the network traffic from assigning the task assignment 160 to access the target device 126. Based on the traffic information 140, the latency module 208 can determine the current traffic latency 154 that the computing system 100 should expect from assigning the task assignment 160. The latency module 208 can communicate the traffic latency 148 to a total module 210.

The computing system 100 can include the total module 210, which can be coupled to the monitor module 204, the access module 206, the latency module 208, or a combination thereof. The total module 210 calculates the total access time 156 of FIG. 1B. For example, the total module 210 can calculate the total access time 156 based on the device access time 146, the traffic latency 148, the traffic information 140, or a combination thereof.

More specifically as an example, the total module 210 can calculate the total access time 156 with the following equation:

Total access time 156=Device access time 146+traffic latency 148+traffic information 140

The monitor block 138 can execute the total module 210. The total module 210 can communicate the total access time 156 to a scheduler module 212.

The computing system 100 can include the scheduler module 212, which can be coupled to the total module 210. The scheduler module 212 distributes the task assignment 160. For example, the scheduler module 212 can distribute the task assignment 160 based on the total access time 156, the storage type 104, the target location 130, the device performance criteria 122, the data location 134, or a combination thereof. The scheduler block 158 can execute the scheduler module 212.

The scheduler module 212 can distribute the task assignment 160 in a number of ways. For example, the scheduler module 212 can distribute the task assignment 160 based on the target location 130. More specifically as an example, the scheduler module 212 can prioritize the distribution of the task assignment 160 to the target device 126 with the target location 130 local to the computing block 106 over the target device 126 with the target location 130 remote from the computing block 106.

For a different example, the scheduler module 212 can distribute the task assignment 160 based on the storage type 104, the target location 130, or a combination thereof. More specifically as an example, the scheduler module 212 can prioritize the distribution of the task assignment 160 to the target device 126 representing the high performance device 114 over the low performance device 116. For further example, the scheduler module 212 can prioritize the distribution of the task assignment 160 to the high performance device 114 local to the computing block 106 over the high performance device 114 remote from the computing block 106. For a different example, the scheduler module 212 can prioritize the distribution of the task assignment 160 to the high performance device 114 remote from the computing block 106 over the low performance device 116 local to the computing block 106.

For another example, the scheduler module 212 can distribute the task assignment 160 based on the device performance criteria 122. More specifically as an example, the scheduler module 212 can prioritize the distribution of the task assignment 160 to the target device 126 having higher value of the device performance criteria 122. For a specific example, the scheduler module 212 can prioritize the distribution of the task assignment 160 to the target device 126 having higher processing capability, throughput level, storage capacity, low latency, or a combination thereof.

It has been discovered that the computing system 100 distributing the task assignment 160 based on the device performance criteria 122, the storage type 104, or a combination thereof improves the efficiency of accessing the target device 126. By factoring the device performance criteria 122, the storage type 104, or a combination thereof, the computing system 100 can select the target device 126 that can provide the data content 102 with the quickest turnaround. As a result, the computing system 100 can reallocate resource to operate the computing system 100 more efficiency.

For another example, the scheduler module 212 can distribute the task assignment 160 based on the total access time 156. More specifically as an example, the scheduler module 212 can distribute the task assignment 160 based on the total access time 156 with the shortest time to access the target device 126. As discussed above, a plurality of the target device 126 can be accessed for assigning the task assignment 160. And the total access time 156 to access each instances of the target device 126 can be different. The scheduler module 212 can distribute the task assignment 160 to the target device 126 with the total access time 156 that is the shortest.

It has been discovered that the computing system 100 distributing the task assignment 160 based on the total access time 156 improves the efficiency of accessing the target device 126. By factoring the total access time 156, the computing system 100 can select the target device 126 that can provide the data content 102 with the quickest turnaround. As a result, the computing system 100 can reallocate resource to operate the computing system 100 for improved efficiency.

For a different example, the scheduler module 212 can distribute the task assignment 160 based on the device performance criteria 122 representing a power consumption of the target device 126. The power consumption can be measured based on a performance per watt. More specifically as an example, the scheduler module 212 can distribute the task assignment 160 to the target device 126 requiring least amount of power consumption to conserve resource for executing the task assignment 160. The scheduler module 212 can communicate the task assignment 160 to an execution module 214.

The computing system 100 can include the execution module 214, which can be coupled to the scheduler module 212. The execution module 214 can execute the command. For example, the execution module 214 can execute the read command 136 based on how the task assignment 160 is distributed. The target device 126 can execute the execution module 214. More specifically as an example, the execution module 214 can execute the read command 136 to read the data content 102 from the target device 126 with the task assignment distributed.

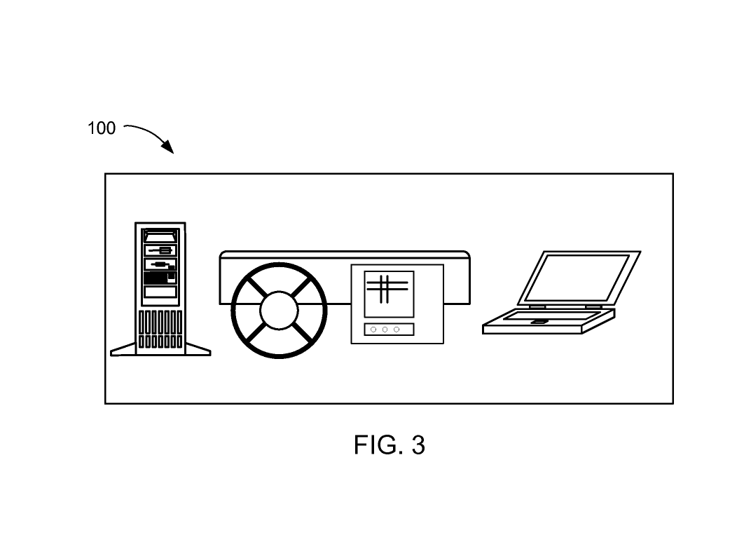

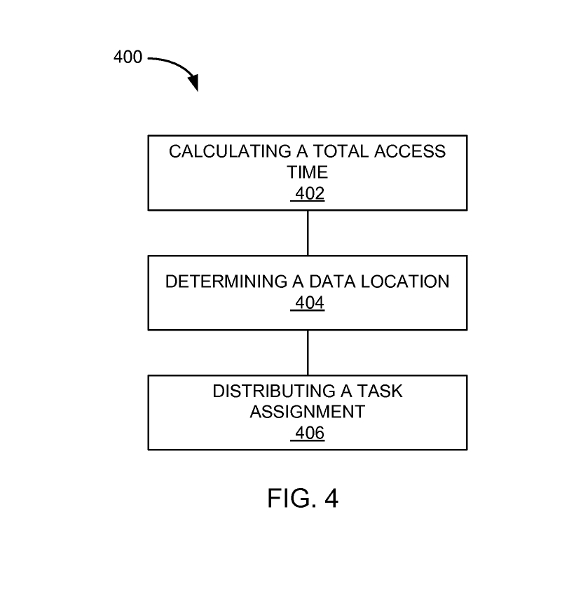

Referring now to FIG. 3, therein are application examples of the computing system 100 with an embodiment of the present invention. FIG. 4 depicts various embodiments, as examples, for the computing system 100, such as a computer server, a dash board of an automobile, a smartphone, a mobile device, and a notebook computer.

These application examples illustrate the importance of the various embodiments of the present invention to provide improved efficiency for accessing the data content 102 of FIG. 1A. The computing system 100 can access the data content 102 from the target device 126 of FIG. 1A providing the shortest instance of the total access time 156 of FIG. 1B, the highest performance for the device performance criteria 122 of FIG. 1A, or a combination thereof.

The computing system 100, such as the computer server, the dash board, and the notebook computer, can include a one or more of a subsystem (not shown), such as a printed circuit board having various embodiments of the present invention or an electronic assembly having various embodiments of the present invention. The computing system 100 can also be implemented as an adapter card.

Referring now to FIG. 4, therein is shown a flow chart of a method 400 of operation of a computing system 100 in an embodiment of the present invention. The method 400 includes: calculating a total access time based on a device access time, a traffic latency, a traffic information, or a combination thereof in a block 402; determining a data location of a data content with a name node block in a block 404; and distributing a task assignment based on the total access time, the data location, device performance criteria, or a combination thereof for accessing the data content from a target device in a block 406.

The block 406 can include distributing the task assignment based on the device performance criteria for prioritizing the task assignment to the target device having higher value of the device performance criteria over the target device having lower value of the device performance criteria; distributing the task assignment based on a target location for distributing the target assignment to the target location local to a computing block over the target location remote from the computing block; distributing the task assignment based on a storage type for prioritizing the task assignment to a high performance device over a low performance device; and distributing the task assignment based on a storage type for prioritizing the task assignment to a high performance device remote to a computing block over a low performance device local to the computing block.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance. These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a monitor block configured to calculate a total access time based on a device access time, a traffic latency, a traffic information, or a combination thereof;
a name node block, coupled to the monitor block, configured to determine a data location of a data content; and
a scheduler block, coupled to the name node block, configured to distribute a task assignment based on the total access time, the data location, device performance criteria, or a combination thereof for accessing the data content from a target device.

2. The system as claimed in claim 1 wherein the scheduler block is configured to distribute the task assignment based on the device performance criteria for prioritizing the task assignment to the target device having higher value of the device performance criteria over the target device having lower value of the device performance criteria.

3. The system as claimed in claim 1 wherein the scheduler block is configured to distribute the task assignment based on a target location local to a computing block over the target location remote from the computing block.

4. The system as claimed in claim 1 wherein the scheduler block is configured to distribute the task assignment based on a storage type for prioritizing the task assignment to a high performance device over a low performance device.

5. The system as claimed in claim 1 wherein the scheduler block is configured to distribute the task assignment based on a storage type for prioritizing the task assignment to a high performance device remote to a computing block over a low performance device local to the computing block.

6. The system as claimed in claim 1 wherein the monitor block is configured to determine a traffic information based on the task assignment assigned to access the data content from the target device.

7. The system as claimed in claim 1 wherein the monitor block is configured to determine a traffic information based on a plurality of a target access to each instances of the target device.

8. The system as claimed in claim 1 wherein the monitor block is configured to determine a traffic information based on receiving a heartbeat for identifying the target device sending the heartbeat.

9. The system as claimed in claim 1 wherein the monitor block is configured to determine the traffic latency based on a network specification.

10. The system as claimed in claim 1 wherein the monitor block is configured to determine an inherent traffic latency based on a network specification.

11. A method of operation of a computing system comprising:
calculating a total access time based on a device access time, a traffic latency, a traffic information, or a combination thereof;
determining a data location of a data content with a name node block; and
distributing a task assignment based on the total access time, the data location, device performance criteria, or a combination thereof for accessing the data content from a target device.

12. The method as claimed in claim 11 wherein distributing the task assignment includes distributing the task assignment based on the device performance criteria for prioritizing the task assignment to the target device having higher value of the device performance criteria over the target device having lower value of the device performance criteria.

13. The method as claimed in claim 11 wherein distributing the task assignment includes distributing the task assignment based on a target location for distributing the target assignment to the target location local to a computing block over the target location remote from the computing block.

14. The method as claimed in claim 11 wherein distributing the task assignment includes distributing the task assignment based on a storage type for prioritizing the task assignment to a high performance device over a low performance device.

15. The method as claimed in claim 11 wherein distributing the task assignment includes distributing the task assignment based on a storage type for prioritizing the task assignment to a high performance device remote to a computing block over a low performance device local to the computing block.

16. A non-transitory computer readable medium including instructions for execution by a computer block comprising:
calculating a total access time based on a device access time, a traffic latency, a traffic information, or a combination thereof;
determining a data location of a data content; and
distributing a task assignment based on the total access time, the data location, or a combination thereof for accessing the data content from a target device.

17. The non-transitory computer readable medium as claimed in claim 16 wherein distributing the task assignment includes distributing the task assignment based on the device performance criteria for prioritizing the task assignment to the target device having higher value of the device performance criteria over the target device having lower value of the device performance criteria

18. The non-transitory computer readable medium as claimed in claim 16 wherein distributing the task assignment includes distributing the task assignment based on a target location for distributing the target assignment to the target location local to a computing block over the target location remote from the computing block.

19. The non-transitory computer readable medium as claimed in claim 16 wherein distributing the task assignment includes distributing the task assignment based on a storage type for prioritizing the task assignment to a high performance device over a low performance device.

20. The non-transitory computer readable medium as claimed in claim 16 wherein distributing the task assignment includes distributing the task assignment based on a storage type for prioritizing the task assignment to a high performance device remote to a computing block over a low performance device local to the computing block.
